(19) United States
(12) Patent Application Publication
(10) Pub. No.: US 2017/0173762 A1
(43) Pub. Date: Jun. 22, 2017

(54) SYSTEM FOR CLAMPING A PART AND METHOD FOR SEALING THE INNER CASING OF A LOW PRESSURE RECTIFIER OF A TURBOMACHINE

(71) Applicant: SAFRAN AIRCRAFT ENGINES, Paris (FR)

(72) Inventors: Romain Rene Marcel CHARDONNET, Moissy-Cramayel Cedex (FR); Jean-Yves Francois Henri MAILLET, Moissy-Cramayel Cedex (FR); Erwan SOUBIGOU, Moissy-Cramayel Cedex (FR)

(21) Appl. No.: 15/118,457

(22) PCT Filed: Feb. 12, 2015
(86) PCT No.: PCT/FR2015/050354

§ 371 Date: Aug. 11, 2016

(30) Foreign Application Priority Data
Feb. 14, 2014 (FR) 1451204

(51) Int. Cl. B25B 5/14; F01D 9/02; F01D 25/28; B25B 5/06

(52) U.S. Cl. CPC B25B 5/14; B25B 5/061; F01D 9/02; F01D 25/285; F05D 2220/30; F05D 2230/30; F05D 2300/516

(57) ABSTRACT

The invention relates to a clamping system (1) comprising a clamping jaw (7) mounted on the shaft of a pneumatic or hydraulic cylinder (4), wherein said cylinder has a structure which drives the clamping jaw towards its clamping position when the pneumatic or hydraulic energy supply of the cylinder is interrupted, the pneumatic or hydraulic energy supply of the cylinder opposing the clamping, and where means (8) are provided for locking the cylinder when the clamping jaw is in a non-clamped position.

### GENERAL TECHNICAL FIELD AND PRIOR ART

The present invention generally relates to clamping of parts.

It finds application advantageously in the field of aeronautics for the implementation of sealing operations and/or abradable material injection on inner ferrules of low-pressure guide vanes of turbine engines.

### PRIOR ART

It is conventional to hold parts in precise positions on work benches using reference clamps.

In particular, clamping systems with manual adjustment are known. Such a system comprises for example a holding pad which forms a first jaw and which is coupled to a clamping screw. Said clamping screw runs through said pad and is engaged in a reference support on which it is desired to position the part during work.

Such a manual system has the disadvantage of not allowing uniform clamping from one clamp to another and requiring long setup times.

Moreover, the force exerted on the part is not repeatable and can be strongly variable from one operator to another.

In addition, clamping systems using hydraulic or pneumatic control are known.

There, clamping is accomplished by hydraulic or pneumatic compression.

This assumes however that a considerable hydraulic or pneumatic energy store is available, and to be able in particular to have safety reserves to deal with cases of possible failure in production of hydraulic or pneumatic energy.

The matter of energy and the maintenance of these systems are expensive.

The control and supervision of the clamping pressure has also proven to be complex.

Moreover, these techniques are poorly adapted to sealing operations and/or abradable material injection on inner ferrules of a low-pressure guide vane of a turbine engine.

In fact, during these operations, the guide vane must be put in rotation. Clamping by pneumatic or hydraulic energy would make it necessary to be able to accompany this rotation with winding of the hydraulic or pneumatic supply pipes, which is particularly complex to organize.

In particular, the centre of the guide vane cannot be used to allow such pipes to pass through, given that it is used for other functions in these operations.

Among these clamping system with hydraulic or pneumatic control, there are systems for which the control triggers the disengagement of the system (document EP 1 310 331 A2).

### GENERAL PRESENTATION OF THE INVENTION

One aim of the invention is to resolve the problems of the prior art and to propose a system that does not have the aforementioned disadvantages.

More particularly, the invention proposes a clamping system including a clamping jaw mounted on the rod of a pneumatic or hydraulic ram, wherein said ram is a structure which, when supply to said ram of pneumatic or hydraulic energy is cut off, drives the clamping jaw toward its clamping position, supply to said ram of pneumatic or hydraulic energy opposing said clamping, characterized in that it includes means of locking the ram when the clamping jaw is in the release position.

The clamping system proposed makes it possible to hold the part clamped when the pneumatic supply is cut off. The various needs for supply, for energy storage, etc. are thereby eliminated.

Clamping is made very reliable and without risk for the operator.

In particular, clamping is made repeatable, whatever the type of clamp.

Because it is made permanent, the system requires few or no maintenance operations.

The invention also proposes a method of sealing and/or injection of abradable material on the inner ferrule of a low-pressure guide vane of a turbine engine, characterized in that it comprises the following steps:
positioning, on a work bench, clamps including a clamping system of the aforementioned type,
positioning the guide vane on said bench,
removing the locking means of the ram located at the outer ferrule,
clamping at least one clamp by cutting off its pneumatic or hydraulic supply.

It also proposes tooling for sealing and/or injection of abradable material on the inner ferrule of a low-pressure guide vane of a turbine engine, characterized in that it includes a work bench and at least one clamp including such a clamping system.

### PRESENTATION OF THE FIGURES

Other features and advantages of the invention will still be revealed by the description that follows, which is purely illustrative and not limiting, and must be read with reference to the appended figures wherein:

FIG. 1 shows schematically in perspective a low-pressure guide vane of a turbine engine;

FIG. 2 illustrates schematically the principle of a positive clamping system conforming to a possible embodiment of the invention;

FIG. 3 shows in perspective an embodiment for the clamping system of FIG. 2;

FIG. 4 illustrates a utilization example for clamping the inner ferrule or the outer ferrule of a low-pressure guide vane of a turbine engine.

### DESCRIPTION OF ONE OR MORE EMBODIMENTS OR IMPLEMENTATIONS

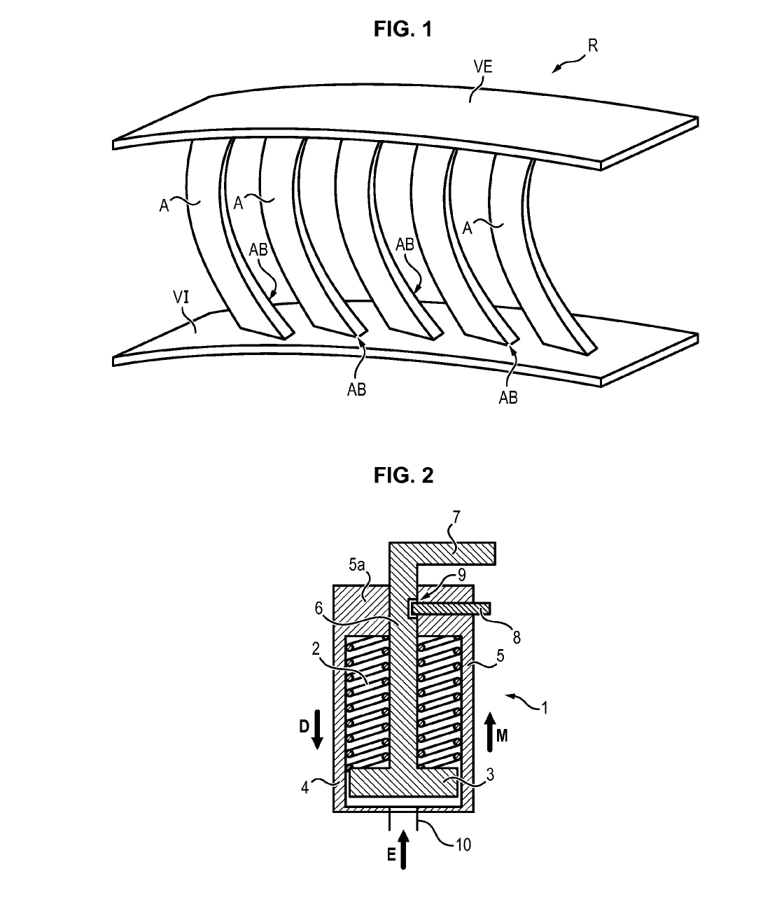

The guide vane R illustrated in FIG. 1 comprises an inner ferrule VI, an outer ferrule VE and blades A assembled by welding to the inner ferrule VE.

These blades A are secured with the inner ferrule VI through an abradable surface AB.

The deposit of this abradable surface is accomplished during sealing and injection operations requiring clamping of the outer ferrule VE and the inner ferrule VI on a support structure of a work bench.

To this end, the inner ferrule VI and the outer ferrule VE are held at several points by means of reference clamps.

To accomplish this, it is proposed to use clamping systems with permanent clamping of the system 1 type illustrated in FIG. 2.

Such a clamping system is a system including one or more springs 2 exerting a force on the piston 3 of a ram 4 which is used to accomplish said clamping.

The hydraulic/pneumatic circuit 10 is provided, but only to ensure release of the clamping system 1, no supply being required for clamping.

In the schematic example illustrated in FIG. 2, one or more spring(s) 2 is (are) compressed between the piston 3 and the bottom 5a of the body 5 of the ram 4. The piston 3 is secured to the rod 6 of the ram, which extends out of the body 5. At its end opposite the piston 3, said rod 6 is itself secured to a clamping jaw 7.

A cam 8 is provided for blocking the clamping jaw 7 and the rod 6 in a high, disengaged position (release position). To this end, said cam 8 cooperates with a groove 9 which the rod 6 has and in which it is possible to engage said cam 8 when the jaw 7 is in the high position.

The positioning of the cam on the ram 4 or its disengagement is for example carried out manually.

When the cam 8 and the groove 9 are disengaged, the springs 2 push back the piston 3 of the ram 4. Said piston 3 moves within the body 5 of the ram 4. The jaw 7, which moves with the piston 3, is movable in the descending direction along arrow D to accomplish the clamping of the part to be clamped.

Release is obtained by supplying pneumatic energy from the circuit 10 along arrow E. A force is exerted against the piston 3, which is movable in the rising direction along arrow M within said body 5 and compresses the springs 2.

When the pneumatic/hydraulic energy is cut off, on the other hand, the springs 2 exert their compression force, but the jaw 7 remains in its high, release position if the cam 8 has been engaged in the groove 9.

It can further be provided that the movement of the piston 3 and the rod 6 within the body 5 of the ram 4 occurs in a helical movement making it possible to have the jaw 7 rotate 90 degrees on itself when it moves toward the release position. Such a helical movement facilitates the disengagement of the part to be clamped.

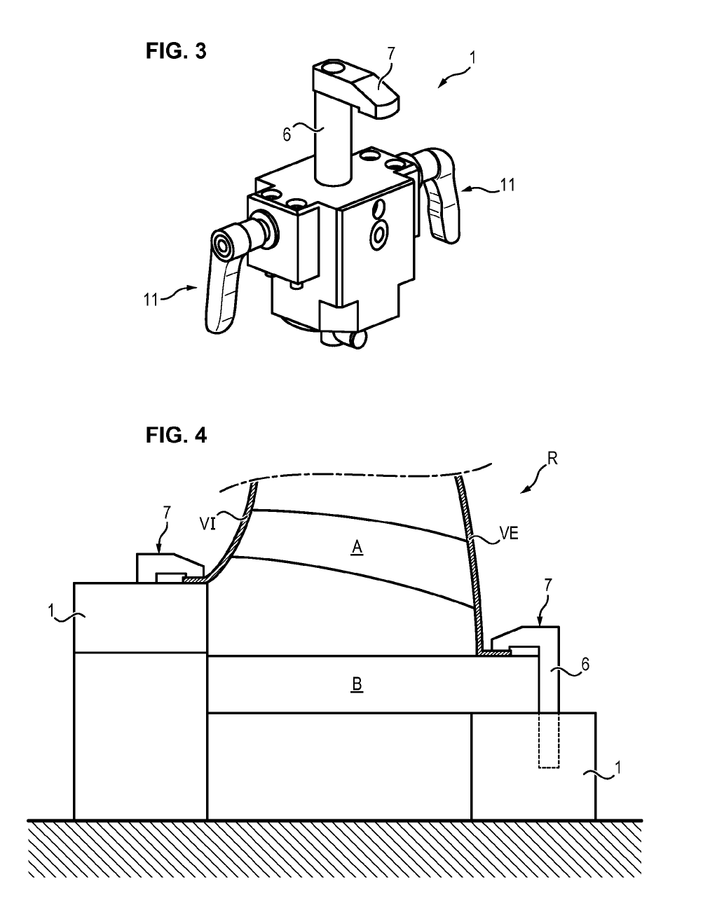

Moreover, as shown in FIG. 3, the body 5 of the ram 4 can be associated with different means 11 (clamping jaws for example) which make it possible to attach the system 1 with precision to a given support.

FIG. 4 illustrates the use of the clamping system of the system 1 type which was just described to accomplish the positioning of the ferrules VI and VE of a guide vane R on a work bench B.

The different reference clamps 1 are first of all attached precisely to the bench B using the attachment means 11 (FIG. 3) which they comprise, the clamps 1 and the bench B constituting a portion of the intervention tooling.

Then the guide vane R is installed on said bench B.

The blocking cams of the reference clamps 1 located at the outer ferrule VE are then removed.

These reference clamps 1 are then clamped to the outer ferrule VE by cutting off the pneumatic pressure in the circuit.

The ferrule VE thus being clamped, clamping of the outer ferrule VI is then carried out.

The guide vane R thus being held in position on the work bench B, the sealing operations are accomplished on inner surfaces of the inner ferrule as well as in its mortises.

Sealing is accomplished for example by depositing RTV silicone. This makes it possible to generate sealing of the path prior to injection of the abradable material itself.

The polymerization of the abradable material is then accomplished on the mortises of the inner ferrule.

The release/unlocking of the different clamps 1 is then ensured by putting the different clamps under hydraulic/pneumatic pressure.

When the different cams 8 are repositioned, the hydraulic/pneumatic pressure can again be cut off.

The reference clamps 1 can then be removed.

When the clamps 1 are not used, the cams 8 can be disengaged so as to limit the loading of the springs 2.

It is understood that the energy thus required for accomplishing clamping is small.

Moreover, the clamping that is carried out is particularly reliable and is not dependent on the level of hydraulic/pneumatic pressure provided by the circuits.

It is repeatable, the clamping being the same no matter which clamp it is.

It is accomplished quickly and without effort by the user who carries out the clamping.

It does not require large amounts of hydraulic/pneumatic energy storage.

It requires only very little maintenance.

1. A clamping system including a clamping jaw mounted on the rod of a pneumatic or hydraulic ram, wherein said ram is a structure which, when supply to said ram of pneumatic or hydraulic energy is cut off, drives the clamping jaw toward its clamping position, supply to said ram of pneumatic or hydraulic energy opposing said clamping, wherein it includes means of locking the ram when the clamping jaw is in the release position.

2. The clamping system according to claim 1, wherein said ram includes a piston and at least one compression spring which acts against the piston, the clamping jaw being linked to said piston and being displaced, to accomplish its clamping, under the compression force of said spring(s).

3. The clamping system according to claim 1, wherein the structure of the ram is adapted so that the displacement of the clamping jaw between its clamping and release positions occurs in a helical movement.

4. The clamping system according to claim 3, wherein the rotation of the clamping jaw between the clamping and release positions is 90°.

5. A method of sealing and/or injection of abradable material on the inner ferrule of a low-pressure guide vane of a turbine engine, wherein it includes the following steps of:
Positioning, on a work bench, clamps including a clamping system according to one of the preceding claims,
positioning the guide vane on said bench,
removing the locking means of the ram located at the outer ferrule,
clamping at least one clamp by cutting off its pneumatic or hydraulic supply.

6. The method according to claim 5, wherein the clamping of the outer ferrule is carried out, then the clamping of the inner ferrule.

7. The method according to claim 5, wherein, after the sealing and/or polymerization operations, the clamps are unlocked by pneumatic or hydraulic supply.

8. The tooling for sealing and/or injection of abradable material on the inner ferrule of a low-pressure guide vane of a turbine engine, wherein it includes a work bench and at least one clamp including a clamping system according to one of claim 1.
